(19) United States
(12) Patent Application Publication
(10) Pub. No.: US 2008/0239157 A1
(43) Pub. Date: Oct. 2, 2008

(54) Memory Efficient Gamma Correction For Multiple Display Devices

(76) Inventor: Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/693,972

(22) Filed: Mar. 30, 2007

(51) Int. Cl. H04N 5/202

(52) U.S. Cl. 348/674

(57) ABSTRACT

One embodiment is directed to a gamma correction unit. The gamma correction unit includes a first and at least one second lookup table. In addition, the gamma correction unit includes a first and at least one second selecting circuits, and at least one combining circuit. The first lookup table may store a reference function. Each reference function value may be M bits. The first selecting circuit selects a reference function value in the first lookup table that corresponds with a particular input value. The at least one second lookup table may store a difference function. Each difference function value may be no more than N bits, where M is greater than N. The at least one second selecting circuit selects a difference function value in the second lookup table that corresponds with the particular input value. The at least one combining circuit combines the selected reference function value with the selected difference function value to produce an output value that corresponds with the particular input value.

### FIELD OF INVENTION

The present invention is in the field of image processing. More specifically, the present invention relates to minimizing memory requirements when converting an input signal into an output signal for driving one of two or more supported display devices.

### BACKGROUND

The image in a display device is formed from a matrix of small picture elements or pixels. The luminance of a particular pixel depends on the input signal driving the pixel in the display device. While linear increases in the input signal might be expected to produce a corresponding increase in the luminance of a pixel, this is typically not the case. In general, pixel luminance does not increase linearly with the input signal.

In a conventional CRT, for example, the luminous intensity of a pixel is proportional to the input signal raised to the power of a constant, usually referred to as gamma, i.e., Iₒᵤₜ=Iᵢₙ^{γ}. In this function, the input signal is limited to a range of between zero and one, but in practice the input signal may be a non-negative integer representative of a fractional amount, expressed as a binary number. For example, when the input level is expressed in an eight-bit word, the values 0 and 255 correspond respectively with input levels of zero and one. FIG. 1 shows an example of a transfer function for a CRT display device, designated γ₁.

For proper image rendering, it is important to accurately correct for the nonlinearity of a display device. To achieve a linear gradation of luminous intensity, the source signal is generally modified before it is input to the display device by a correction transfer function, which is the inverse of the display device transfer function, e.g., Iₒᵤₜ=Iᵢₙ^{1/γ}. FIG. 1 also shows an example of a correction transfer function, designated 1/γ₁. A dashed line represents a linear source signal as first modified according to the correction transfer function and then modified according to the display device transfer function. The dashed line shows that the displayed intensity bears a linear relationship to the source signal as a result of the source signal being modified with the correction function before being input to the display device.

Different types of display devices have different transfer functions. The transfer function of the typical LCD, for example, is s-shaped. In addition, different display devices of the same type may have different transfer functions. Thus, in order to support multiple display devices it may be necessary to provide multiple distinct correction transfer functions.

Where multiple display devices are supported, there is a need for memory efficient gamma correction.

### SUMMARY

One embodiment is directed to a gamma correction unit. The gamma correction unit includes a first and at least one second lookup table. In addition, the gamma correction unit includes a first and at least one second selecting circuits, and at least one combining circuit. The first lookup table may store a reference function. Each reference function value may be M bits. The first selecting circuit selects a reference function value in the first lookup table that corresponds with a particular input value. The at least one second lookup table may store a difference function. Each difference function value may be no more than N bits, where M is greater than N. The at least one second selecting circuit selects a difference function value in the second lookup table that corresponds with the particular input value. The at least one combining circuit combines the selected reference function value with the selected difference function value to produce an output value that corresponds with the particular input value.

The particular input value may be one of a set of I input values. The second lookup table may store K corresponding difference function values. In one alternative, I equals K. In another alternative, I is greater than K.

Another embodiment is directed to a system. The system includes a display controller. The display controller includes a first and at least one second lookup table. In addition, the display controller includes a first and at least one second selecting circuits, and at least one combining circuit. The first lookup table may store a reference function. Each reference function value may be M bits. The first selecting circuit selects a reference function value in the first lookup table that corresponds with a particular input value. The at least one second lookup table may store a difference function. Each difference function value may be no more than N bits, where M is greater than N. The at least one second selecting circuit selects a difference function value in the second lookup table that corresponds with the particular input value. The at least one combining circuit combines the selected reference function value with the selected difference function value to produce an output value that corresponds with the particular input value.

The particular input value may be one of a set of I input values. For each input value in the set, the second lookup table may store K corresponding difference function values. In one alternative, I equals K. In another alternative, I is greater than K. In addition, the system may include at least one display device. Further, the system may include at least one image data source. Moreover, the display controller may be incorporated in a mobile device.

In yet another embodiment, a method includes: (a) receiving an input value; (b) looking up a reference function value corresponding to the input value in a first lookup table. The first lookup table may store the reference function and each reference function value may be M bits. The method may also include: (c) looking up a difference function value corresponding to the input value in a second lookup table. The second lookup table may store the difference function and each difference function value may be no more than N bits, where M is greater than N. Further, the method may include: (d) combining the reference and difference function values corresponding to the input value to produce an output value.

The particular input value may be one of a set of I input values. For each input value in the set, the second lookup table may store K corresponding difference function values. In one alternative, I equals K. In another alternative, I is greater than K.

Moreover, the method may include a step of subtracting a first function from the reference function to produce the difference function. The first function may be a gamma correction function for a first display device and the reference function may be a gamma correction function for a second display device. In addition, the method may be implemented partially or completely in hardware.

### BRIEF DESCRIPTION OF THE DRAWINGS

FIG. 1 is a graphical example of a transfer function γ₁ and a correction transfer function 1/γ₁ for an exemplary display device.

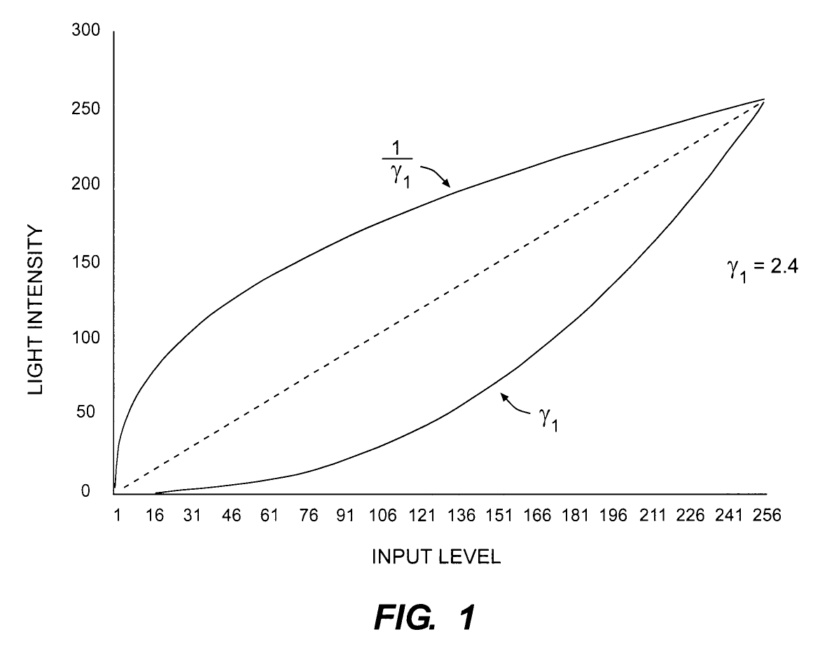

FIG. 2 is a simplified block diagram of one embodiment of a display system for memory efficient gamma correction for multiple display devices, which includes a gamma correction unit.

FIG. 3 is a block diagram of one embodiment of the gamma correction unit of FIG. 2, which includes a device-specific difference-LUT/selecting-circuit pair.

FIG. 4 is a graphical example of a gamma-correction function 1/γ₂ for an exemplary display device, a reference gamma-correction function 1/γ₁, and a device-specific difference function δ.

FIG. 5 is a block diagram of one alternative embodiment of the device-specific difference-LUT/selecting-circuit pair of FIG. 3.

FIG. 6 is a flow diagram of one embodiment of a method for memory efficient gamma correction for multiple display devices.

In the drawings and description below, the same reference numbers are used in the drawings and the description generally to refer to the same or like parts, elements, or steps.

### DETAILED DESCRIPTION

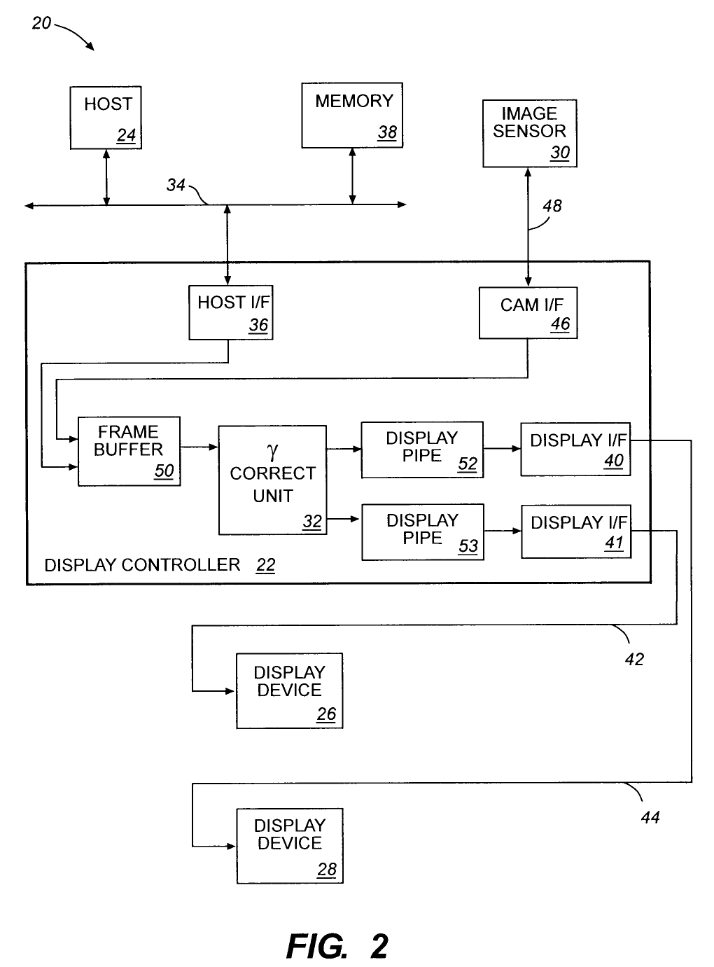

FIG. 2 is a simplified block diagram of one embodiment of a display system for memory efficient gamma correction for multiple display devices. The system 20 may be a mobile device (defined below). Where the system 20 is a mobile device, it is typically powered by a battery (not shown). The system 20 may include a display controller 22, a host 24, one or more display devices 26, 28, and one or more image data sources, such as image sensor 30.

Because the host 24 may be a source of image data, the term “image data source” is intended to include the host 24. While the system 20 includes multiple display devices and image data sources, this is not essential. In other embodiments, a single display device or a single image data source may be provided.

The display controller 22 interfaces the host 24 and image sensor 30 with the display devices 26, 28. In the shown embodiment, the display controller 22 is used to gamma correct image data before it is input to a display device. A gamma correction unit 32 is provided for this purpose. In other embodiments, gamma-correction according to the claimed inventions may be performed in a standalone unit or by other units in a system, e.g., in the image sensor 30. In one embodiment, the display controller 22 is a separate integrated circuit from the remaining elements of a system, that is, the display controller is “remote” from the host, image sensor, and display device.

The host 24 is typically a microprocessor, but may be a digital signal processor, a computer, or any other type of device or machine that may be used to control operations in a digital circuit. Typically, the host 24 controls operations by executing instructions that are stored in or on a machine-readable medium. The host 24 communicates with the display controller 22 over a bus 34 to a host interface 36 in the display controller. Other devices may be coupled with the bus 34. For instance, a memory 38 may be coupled with the bus 34. The memory 38 may, for example, store instructions or data for use by the host 24, or image data that may be rendered using the display controller 22. The memory 38 may be an SRAM, DRAM, Flash, hard disk, optical disk, floppy disk, or any other type of memory.

Display device interfaces 40, 41 are included in the display controller 22. The display device interfaces 40, 41 provide interfaces between the display controller 22 and the display devices 26, 28, respectively. Display device busses 42, 44 couple the display controller 22 and the display devices 26, 28. LCDs are typically used as display devices in mobile devices, but the display devices 26, 28 (defined below) may be any type of display device. In addition, the display devices 26, 28 may have different transfer functions, e.g., display device 26 may have a transfer function of γ₁, and display device 28 may have a transfer function of γ₂. Two or more display devices may be incorporated in a single mobile device. Alternatively, a system may have a different number of display devices at different times. For example, a mobile device having a single display physically incorporated in the device may be coupled with a second display device not physically incorporated in the device. For instance, a docking station for the mobile device may include a display or the mobile device may be coupled from time to time with the display in a television.

The image sensor 30 may be, for example, a charge-coupled device (CCD) or a complementary metal-oxide semiconductor (CMOS) sensor. The image sensor may output image data that is not gamma corrected for a particular display device. A camera interface 46 (“CAM I/F”) is included in the display controller 22. The camera interface 46 is coupled with the image sensor 30 and receives pixel data output on data lines of a bus 48. Typically, the camera interface 46 also receives vertical and horizontal synchronizing signals from the image sensor 30 and provides a clocking signal to the image sensor 30 for clocking pixel data out of the sensor. These signals may be transmitted via the bus 48 or via a separate bus (not shown).

The gamma correction unit 32 receives image data from the image sensor 30 via the camera interface 46, from the host 24 or memory 38 via the host interface 36, or from any other desired image data source. The image data received from any one of these sources may be stored in a memory 50 before being processed by the gamma correction unit 32. In an alternative embodiment, image data need not be stored in the memory 50 before being processed by the gamma correction unit 32. The gamma correction unit 32 is described in more detail below.

The memory 50 may be included in the display controller 22. In other embodiments, however, the memory 50 may be remote from the display controller 22. The memory 50 may be used as a frame buffer for storing image data, but may also be used for storing other types of data. The memory 50 is of the SRAM type, but the memory 50 may be a DRAM, Flash memory, hard disk, optical disk, floppy disk, or any other type of memory. The memory 50 may be coupled with other units within the graphics controller 22 as necessary or desired.

Display pipes 52, 53 may be included in the display controller 22. The gamma correction unit 32 may be coupled with an input to one of the display pipes 52, 53. Outputs of the display pipes 52, 53 may be coupled, respectively, with the display interfaces 40, 41. Thus, gamma-corrected image data may be transferred from the gamma correction unit 32 to one or both of the display devices 26, 28 via the display pipes 52, 53 and the display interfaces 40, 41. The display controller 22 may simultaneously drive the display devices 26, 28 with the image data from the same or different sources, not withstanding that the display devices have different transfer functions, i.e., that they require different gamma correction functions.

Where a system supports one display device, all possible values of a correction transfer function may be stored in a memory in the form of a lookup table. When an input pixel is received, a corresponding entry in the lookup table is located and output to the display device in place of the input pixel. Where multiple display devices are supported, it is necessary to provide one lookup table for each supported device. Mobile devices, such as mobile telephones, must operate with limited memory and are constrained to operate with minimal power consumption so as to maximize battery life. Accordingly, storing multiple look-up tables to support multiple display devices in mobile devices contributes to power consumption and shorter battery life.

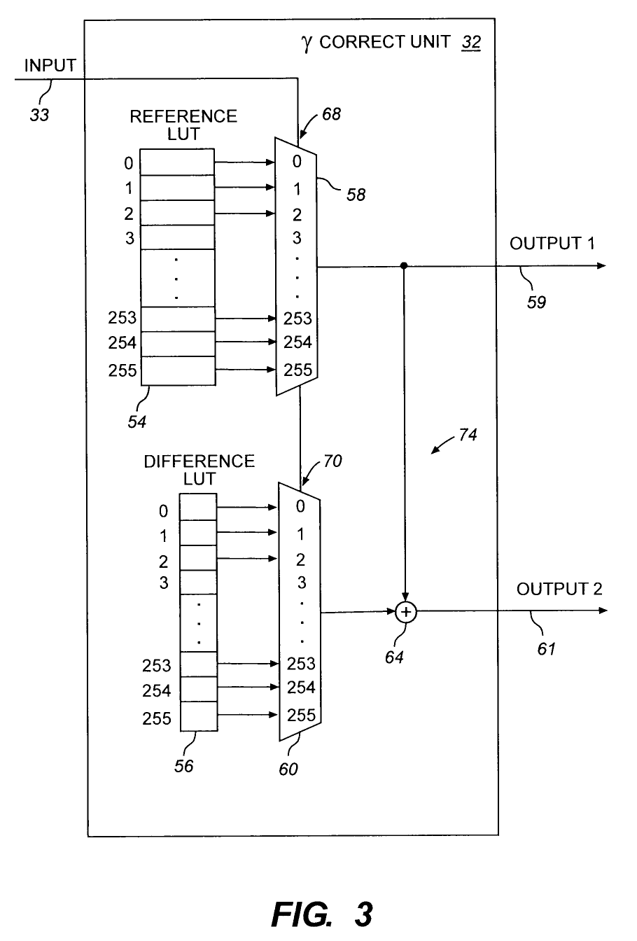

FIG. 3 is a block diagram of one embodiment of the gamma correction unit 32. The exemplary gamma correction circuit 32 includes two lookup tables (LUT): a Reference LUT 54 and a difference LUT 56. Reference LUT 54 and difference LUT 56 may be physically distinct memories or they may be distinct regions of a single memory. The LUTs 54, 56 may be register type memory. Alternatively, the LUTs may be SRAM type memory. In still other alternatives, the LUTs may be a DRAM, Flash memory, hard disk, optical disk, floppy disk, or any other type of memory. In addition, the unit 32 includes selecting circuits 58, 60, and a combining circuit 64.

The gamma correction unit 32 may have an input 33 and two outputs 59, 61. The outputs 59, 61 of the unit 32 may be coupled with the display pipes 52, 53, respectively. The input 33 may be coupled with the memory 50, and with the respective selecting inputs 68, 70 of the selecting circuits 58, 60. The input level on input 33 may be any value in a predetermined set of input values. For example, if pixels of the image are represented by an 8-bit data value, the set of input values ranges from 0 to 255.

In the shown embodiment, the reference LUT 54 stores 256 entries, and the shown selecting circuit 58 is a 256-to-1 multiplexer. In addition, the difference LUT 56 stores 256 entries, and the selecting circuit 60 is a 256-to-1 multiplexer. Further, it is assumed in this example that the set of possible input values has 256 members. The LUT 54 is coupled with the selecting circuit 58 in a manner that permits a distinct one of the 256 entries stored in the LUT 54 to be output from the selecting circuit 58 in response to a corresponding selecting input signal. Similarly, the LUT 56 is coupled with the selecting circuit 60 in a manner that permits a distinct one of the 256 entries stored in the LUT 54 to be output from the selecting circuit 58 in response to a corresponding selecting input signal. For example, if the selecting input signal is 253, then the 253^{rd} entry in the LUT 54 is output from the selecting circuit 58 and the 253^{rd} entry in the LUT 56 is output from the selecting circuit 60.

The output of the selecting circuit 58 is provided as an output of the unit 32, which is the output 59, and as an input to a combining circuit 64. The shown combining circuit 64 has two inputs, and the output of the selecting circuit 60 is provided as the second input to the combining circuit 64. In addition, the shown combining circuit 64 has one output, which is the output 61 of the unit 32. The outputs 59, 61 may also be referred to as output 1 and 2, respectively, or they may be referred to as “corrected inputs” 1 and 2.

The combining circuit 64 may combine corresponding entries in the reference and difference LUTs 54, 56 to produce an output 2 in any manner desired. In one embodiment, the combining circuit 64 combines by addition. For example, if the selecting input signal is 253, then the combining circuit 64 may sum the 253^{rd} entries of the respective LUTs. In other embodiments, the combining circuit 64 may combine by subtraction, multiplication, division, or a combination of addition, subtraction, multiplication, and division operations.

In one embodiment, the reference LUT 54 stores a reference gamma-correction transfer function, e.g., 1/γ₁, and the difference LUT 56 stores a device-specific difference function, e.g., δ. The reference and difference functions are discrete. The reference gamma-correction function may be any transfer function for gamma correcting a signal. Preferably, the reference gamma-correction function is the gamma-correction transfer function of a supported display device, e.g., device 26.

The device-specific difference function δ is derived from the gamma-correction transfer function, e.g., 1/γ₂, for another display device, e.g., device 28. A gamma-correction function for another display device is preferably the gamma-correction function of a supported display device. The device-specific difference function δ may be derived in a variety of ways. For example, it may be derived by a method that includes subtracting the gamma-correction function of a supported display device from the reference gamma-correction function. In other words, the device-specific difference function may be the difference between the source and reference gamma-correction functions.

Use of the device-specific difference function δ according to the claimed inventions provides a memory savings. A comparison of two examples illustrates the memory savings and introduces other aspects of the disclosed embodiments. As a first example, assume two display devices are to be supported. The first and second display devices require, respectively, first and second gamma-correction functions. Assume that each function value of the first and second gamma-correction functions is an eight-bit word. Also assume that there are 256 possible input values and 256 corresponding function values for each of the first and second gamma-correction functions. The first gamma-correction function is stored in a first LUT and the second gamma-correction function is stored in a second LUT. As each LUT has 256 eight-bit entries, each LUT requires 256 bytes for a total of 512 bytes.

In contrast, consider a second example according to embodiment of the claimed inventions. As before, two display devices are to be supported, and the two display devices require, respectively, first and second gamma-correction functions. Similarly, assume that there are 256 possible input values and 256 corresponding function values for each of the first and second gamma-correction functions. The first gamma-correction function is stored in a first LUT. However, in this second example, the first gamma-correction function is a reference gamma-correction function 1/γ₁. Moreover, unlike the first example, the second gamma-correction function is not stored in a second LUT. Instead, a device-specific difference function δ is stored in the second LUT. In this second example, the first LUT may be reference LUT 54 and the second LUT may be difference LUT 56. Because the device-specific difference function δ may be 256 four-bit words, only 128 bytes of memory are required to store the device-specific difference function in the LUT 56. As the first LUT requires 256 bytes and the second LUT requires 128 bytes, a total of 384 bytes are required. Thus, the second example produces a memory savings of 128 bytes.

As the two examples presented above illustrate, the first and second gamma-correction functions includes 256 eight-bit words, whereas a device-specific difference function δ may include 256 four-bit words. More generally, first and second gamma-correction functions may include M-bit words and a device-specific difference function may include words of no more than N-bits, where M is greater than N. The reason that each value of a device-specific difference function requires fewer bits than a source gamma-correction function is explained next.

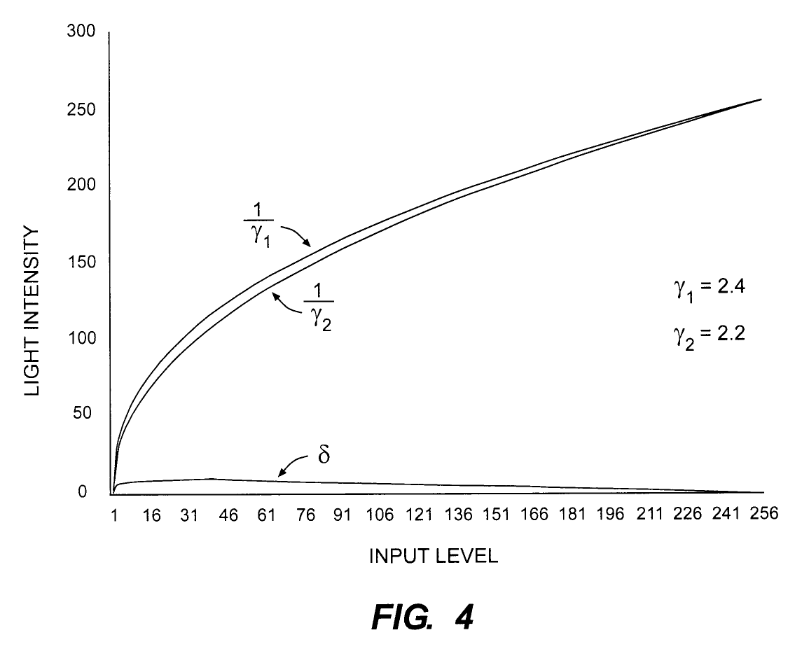

FIG. 4 shows examples of continuous-valued versions of an exemplary reference gamma-correction function and an exemplary gamma-correction function for another display device. In this example, the gamma of the gamma correction function for the other display device is 2.4, while the gamma of the reference gamma correction function is 2.2. FIG. 4 also shows the device-specific difference function δ derived from these two gamma-correction functions. Table 1 below presents values of the difference function shown in FIG. 4 for selected input levels.

TABLE 1

| Input Level | Difference |
|---|---|
| 3 | 6 |
| 50 | 8 |
| 75 | 7 |
| 100 | 6 |
| 125 | 5 |
| 150 | 4 |
| 175 | 3 |
| 200 | 2 |
| 225 | 1 |
| 250 | 0 |

Consider the difference function δ value for the input level of 75, which is 7. In comparison, the values of the other display and reference correction functions for the input level of 75 are, respectively, 153 and 146. Because eight bits are required to store a decimal value of 128 or larger, eight bits are required to store the other display and reference correction functions for the input level of 75. In contrast, the difference function value of 7 may be stored in three bits. As the table above and the graphical representation of FIG. 4 show, the largest value of the device-specific difference function is eight, which has a binary value of 1000b. As the largest difference may be stored in four bits, individual values of the device-specific difference function may be stored in no more than four bits in this example.

Referring again to FIG. 3, in one embodiment, the gamma correction unit 32 operates as follows. First, a pixel (or pixel component) is received. The pixel may be image data intended for the display device 26, 28, or both displays. The pixel may be any number of bits, e.g, eight bits. The selecting circuits 58 and 60 use the received pixel to access corresponding entries in the respective LUTs 54 and 56. In other words, a pixel having a level of I may cause the selecting circuit 58 to access the J^{th} entry in lookup table 54, and the selecting circuit 60 to access the K^{th} entry in lookup table 56. Assuming that there is one entry in each of the LUTs for each value in the set of possible input values, I=J=K. Each selecting circuit then outputs the value it accesses in the respective lookup table. For instance, using the example functions shown in FIG. 4, when a pixel having a level of 3 is received (I=3), the entry for level 3 in the reference gamma correction LUT 54 is 34 (J=3), and the entry for level 3 in the difference LUT 56 is 6 (K=3). Accordingly, the selecting circuit 58 outputs 34 and the selecting circuit 56 outputs 6. The combining circuit 64 then sums 6 and 34, producing an output of 40. The output 1 of 34 is provided to display pipe 52 for rendering on display device 26, which in this example has a display gamma of 2.2. In addition, the output 2 of 40 is provided to display pipe 53 for rendering on display device 28, which in this example has a display gamma of 2.4.

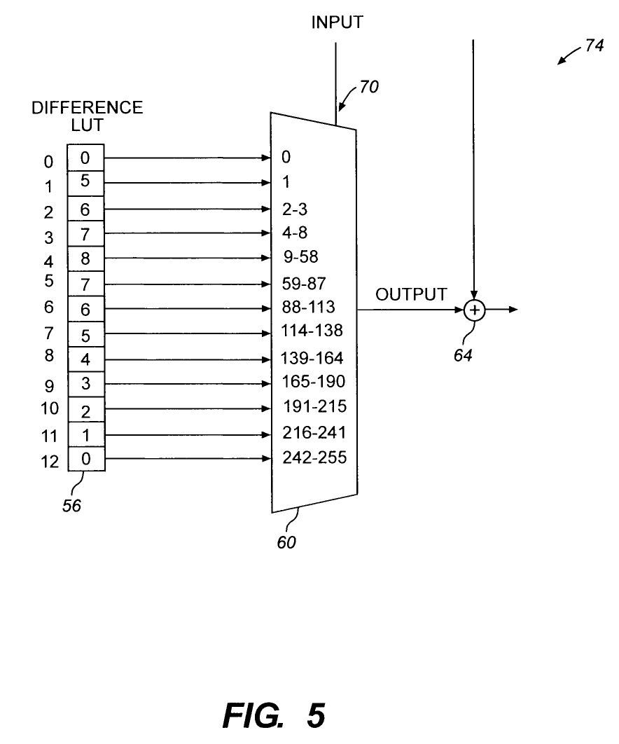

In one embodiment, the selecting circuits 58 and 60 are multiplexers. A multiplexer is one type of decoding circuit. In alternative embodiments, the selecting circuits 58 and 60 may be a decoding circuit of any form. For example, any selecting circuit comprised of discrete logic gates that perform the required decoding function may be employed. A decoding circuit may accept I possible input levels to access J corresponding entries in a reference LUT or K corresponding entries in a difference LUT (I=J=K). Moreover, as will be further explained below with reference to FIG. 5, a decoding circuit paired with a particular difference LUT may accept I possible input levels to access K corresponding entries in a difference LUT, where I is greater than K.

The inventor has recognized that while there may be I possible input levels, there are generally fewer than I possible device-specific difference function values. In one example, there are 256 possible input levels, but there are fewer than 256 possible device-specific difference function values. In particular, in the example of FIG. 4, there are only nine possible values for the difference function, i.e., 0 to 8.

FIG. 5 is a block diagram of one alternative embodiment of a device-specific difference-LUT 56, selecting circuit 60, and combining circuit 64, designated generally as 74. According to one embodiment, the difference LUT 56 stores K values of a device-specific difference function δ that produces S output levels, where I (the number of possible input levels) is greater than K. The exemplary device-specific difference LUT 56 shown in FIG. 5 stores K=13 values of a device-specific difference function δ where the number of possible input levels I=256. Thirteen values may be stored even though there are only nine possible output levels because five values are repeated one time. However, there is much less repetition of levels than with the first example of the LUT 56 shown in FIG. 4. Specifically, by eliminating most of the repeated values, the size of the LUT 56 may be reduced from 256 entries to 13 entries, a reduction of 243 entries. As each entry requires 4 bits, this represents a savings of 972 bits or about 121 bytes.

As another example, all of the duplicate entries may be eliminated from the device-specific difference LUT 56. For instance, for the example difference function shown in FIG. 4, the difference LUT 56 may hold as few as nine entries (K=9).

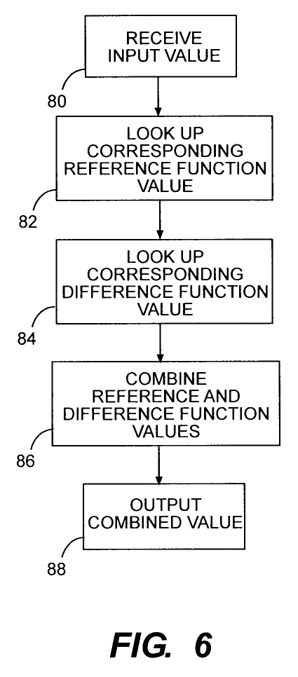

Turning to FIG. 6, a flow diagram of one embodiment of a method for memory efficient gamma correction for multiple display devices is shown. The method includes a first step of receiving an input value (step 80). A reference function value corresponding to the input value is searched for and read out of a first lookup table (step 82). The first lookup table may store the reference function and each reference function value is M bits. A difference function value corresponding to the input value is searched for and read out of in a second lookup table (step 84). The second lookup table may store the difference function and each difference function value is no more than N bits. M may be greater than N. The reference and difference function values corresponding to the input value are combined to produce an output value (step 86). The corresponding values may be combined by adding, subtracting, multiplying, dividing, or by another method. The output value produced in step 86 may be output directly to a display device or to the display device via intermediate units, such as a display pipe or a display interface (step 88).

The method of FIG. 6 may be repeated for each pixel of each pixel in an image, or, as explained below, for each component of each pixel of an image. In addition, the steps of the method may be implemented partially or completely in hardware, or partially or completely in software. Further, the method may include a step of deriving a first function from the reference function to produce the difference function, e.g., by subtracting. The reference function may be a gamma correction function for a particular display device. The first function may be a gamma correction function for any display device other than the particular display device.

For convenience and simplicity of explanation, the examples above use a pixel defined by an 8-bit data value. The claimed inventions are not limited to 8-bit pixels. In various embodiments, a pixel defined by a data value which is greater or less than 8-bits. Moreover, pixels may be defined by two of more component data values (“pixel components”). For instance, each pixel of a color image may be represented by three 8-bit data values, each 8-bit data value being representative of a distinct color component of the pixel, e.g., a red, green, or blue component. In another color model (YUV), each pixel of a color image is represented by a luminance component and two color difference components. According to one embodiment, where a pixel is represented by two or more pixel components, multiple instances of the gamma correction unit 32 may be provided, each instance being designated for gamma-correcting a particular pixel component. For example, 8-bit red pixel components may be input to a gamma correction unit 32a, 8-bit blue pixel components may be input to a gamma correction unit 32b, and 8-bit green pixel components may be input to a gamma correction unit 32c. The gamma correction units may be arranged so that they correct pixel components in parallel or serially.

The exemplary gamma correction unit 32 shown in FIG. 3 is capable of supporting two display devices. However, it may be desired to support three or more display devices. In other embodiments, additional instances of the device-specific difference-LUT 56, selecting circuit 60, and combining circuit 64, designated generally as 74, may be provided. Each set of circuits 74 may be used to gamma correct image data for a distinct display device. For example, a reference LUT 54 may be used to gamma correct input for a first display device; (b) a device-specific difference-LUT 56a, selecting circuit 60a, and combining circuit 64a may be used to gamma correct input for a second display device; and (c) a device-specific difference-LUT 56b, selecting circuit 60b, combining circuit 64b may be used to gamma correct input for a third display device.

Embodiments of the claimed inventions may be used in a “mobile device.” A mobile device, as the phrase is used in this description and the claims, means a computer or communication system, such as a mobile telephone, personal digital assistant, digital music player, digital camera, or other similar device. Embodiments of the claimed inventions may be employed in any device capable of processing image data, including but not limited to computer and communication systems and devices generally.

The term “display device” is used in this description and the claims to refer to any of device capable of rendering images. For example, the term display device is intended to include hardcopy devices, such as printers and plotters. The term display device additionally refers to all types of display devices, such as CRT, LED, OLED, and plasma devices, without regard to the particular display technology employed.

The gamma correction unit 32 may be comprised of a plurality of discrete logic gates and devices selected and designed to perform the functions described as well as other functions. Alternatively, the gamma correction unit 32 may be comprised of logic gates and devices produced by a hardware definition language, such as Verilog™ or VHDL. In another alternative, the gamma correction unit 32 may be comprised of a suitable processor and a memory to execute a program of instructions stored in the memory, wherein the program of instructions when executed by the processor performs a method for memory efficient gamma correction, as described above.

The claimed inventions may be embodied as a machine readable medium embodying a program of instructions for execution by the machine to perform a method gamma correcting image data. The machine or computer readable medium may be any data storage device that can store data which can be thereafter read by a computer system. Examples of the computer readable medium include flash memory, hard drives, network attached storage, ROM, RAM, CDs, magnetic tapes, and other optical and non-optical data storage devices. The computer readable medium can also be distributed over a network-coupled computer system so that the computer readable code is stored and executed in a distributed fashion.

In this document, particular structures, processes, and operations well known to the person of ordinary skill in the art may not be described in detail in order to not obscure the description. As such, embodiments of the claimed inventions may be practiced even though such details are not described. On the other hand, certain structures, processes, and operations may be described in some detail even though such details may be well known to the person of ordinary skill in the art. This may be done, for example, for the benefit of the reader who may not be a person of ordinary skill in the art. Accordingly, embodiments of the claimed inventions may be practiced without some or all of the specific details that are described.

In this document, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

I claim:

1. A gamma correction unit comprising:
(a) a first lookup table to store a reference function, each reference function value being M bits;
(b) a first selecting circuit to select a reference function value in the first lookup table that corresponds with a particular input value;
(c) at least one second lookup table to store a difference function, each difference function value being no more than N bits, wherein M is greater than N;
(d) at least one second selecting circuit to select a difference function value in the second lookup table that corresponds with the particular input value; and
(e) at least one combining circuit to combine the selected reference function value with the selected difference function value to produce an output value that corresponds with the particular input value.

2. The gamma correction unit of claim 1, wherein the combining circuit combines by addition.

3. The gamma correction unit of claim 1, wherein the combining circuit combines by subtraction.

4. The gamma correction unit of claim 1, wherein the particular input value is one of a set of I input values, the second lookup table stores K difference function values, and I equals K.

5. The gamma correction unit of claim 1, wherein the particular input value is one of a set of I input values, the second lookup table stores K difference function values, and I is greater than K.

6. The gamma correction unit of claim 1, wherein the at least one second lookup table includes two lookup tables, one lookup table to store a first difference function, the other lookup table to store a second difference function.

7. The gamma correction unit of claim 1, wherein the gamma correction unit is disposed in an image sensor.

8. A system comprising:
a display controller including,
(a) a first lookup table to store a reference function, each reference function value being M bits;
(b) a first selecting circuit to select a reference function value in the first lookup table that corresponds with a particular input value;
(c) at least one second lookup table to store a difference function, each difference function value being no more than N bits, wherein M is greater than N;
(d) at least one second selecting circuit to select a difference function value in the second lookup table that corresponds with the particular input value; and
(e) at least one combining circuit to combine the selected reference function value with the selected difference function value to produce an output value that corresponds with the particular input value

9. The system of claim 8, wherein the particular input value is one of a set of I input values, the second lookup table stores K difference function values, and I equals K.

10. The system of claim 8, wherein the particular input value is one of a set of I input values, the second lookup table stores K difference function values, and I is greater than K.

11. The system of claim 8, further comprising at least one display device.

12. The system of claim 8, wherein the system is incorporated in a mobile device.

13. A method comprising:
(a) receiving an input value;
(b) looking up a reference function value corresponding to the input value in a first lookup table, the first lookup table to store the reference function, each reference function value being M bits;
(c) looking up a difference function value corresponding to the input value in a second lookup table, the second lookup table to store the difference function, each difference function value being no more than N bits, wherein M is greater than N; and
(d) combining the reference and difference function values corresponding to the input value to produce an output value.

14. The method of claim 13, wherein the particular input value is one of a set of I input values, the second lookup table stores K difference function values, and I equals K.

15. The method of claim 13, wherein the particular input value is one of a set of I input values, the second lookup table stores K difference function values, and I is greater than K.

16. The method of claim 13, wherein the method is embodied in a machine readable medium embodying a program of instructions for execution by the machine to perform the steps (a) to (d).

17. The method of claim 13, further comprising subtracting a first function from the reference function to produce the difference function, wherein the first function is a gamma correction function for a first display device.

18. The method of claim 17, wherein the reference function is a gamma correction function for a second display device.

19. The method of claim 18, wherein the method is embodied in a machine readable medium embodying a program of instructions for execution by the machine.

20. The method of claim 13, further comprising outputting the output value.
